(19) United States
(12) Patent Application Publication
(10) Pub. No.: US 2026/0084493 A1
(43) Pub. Date: Mar. 26, 2026

(54) REFRIGERANT UNIT

(71) Applicant: SANDEN CORPORATION, Gunma (JP)

(72) Inventors: Ryosuke HAYASHI, Isesaki-shi (JP); Takahiro TOMARU, Isesaki-shi (JP)

(73) Assignee: SANDEN CORPORATION, Gunma (JP)

(21) Appl. No.: 19/108,919

(22) PCT Filed: Aug. 29, 2023
(86) PCT No.: PCT/JP2023/031306

§ 371 Date: Mar. 5, 2025

(30) Foreign Application Priority Data
Sep. 26, 2022 (JP) 2022-152469

(51) Int. Cl. B60H 1/32

(52) U.S. Cl. CPC B60H 1/3229

(57) ABSTRACT

To reduce heat exchangers having different functions from being thermally affected by each other, and to respond to a desired temperature requirement for a temperature adjustment target. Provided is a refrigerant unit 10 including a refrigerant circuit and a single support member 12 that collectively supports components of the refrigerant circuit. The refrigerant circuit includes a first heat exchanger 30 and second heat exchangers 41, 42 having different functions. The first heat exchanger is disposed between the plurality of the second heat exchangers. A distance from one side of the plurality of second heat exchangers to the first heat exchanger is greater than a distance from the other side of the plurality of second heat exchangers to the first heat exchanger.

### TECHNICAL FIELD

The present invention relates to a refrigerant unit.

### BACKGROUND ART

A heat management system for a vehicle or the like performs heat management for a temperature adjustment target such as vehicle interior air-conditioning using heat absorption and dissipation of a refrigerant circuit. Components of the refrigerant circuit which is the core of the heat management system are required to be compactly unitized in order to enable centralized management in a device such as a vehicle or to enable space-efficient component arrangement in the device.

In the unitized refrigerant circuit (refrigerant unit), a compressor, a heat exchanger functioning as an evaporator or a condenser, a decompression device (expansion valve), a gas-liquid separator (accumulator), and the like, which are the components of the refrigerant circuit, are collectively disposed on a support member serving as a base, and a refrigerant channel (manifold) is formed in the support member, thereby assembling the unit (see Patent Literature 1 below).

### CITATION LIST

### Patent Literature

Patent Literature 1: US 2019/0039440 A

### SUMMARY OF INVENTION

### Problems to be Solved by Invention

In the heat management system, in a case where there is a plurality of temperature adjustment targets, one or both of the heat exchanger functioning as the evaporator of the refrigerant unit and the heat exchanger functioning as the condenser include(s) a plurality of heat exchangers, and each heat exchanger corresponds to each of the plurality of temperature adjustment targets. In this case, a channel for dividing refrigerant into the plurality of heat exchangers functioning as the evaporators or the condensers, or a channel for joining refrigerant from the plurality of heat exchangers is required to have the shortest possible channel length.

Further, in the refrigerant unit, in a case where a plurality of heat exchangers having the same function is provided corresponding to a plurality of temperature adjustment targets, as described above, in order to shorten the channel length of the refrigerant channel, it is preferable to dispose a heat exchanger having a different function between the plurality of heat exchangers having the same function. However, according to this configuration, since the heat exchanger having the heat absorbing function is disposed next to the heat exchanger having the heat dissipating function, the heat exchangers having different functions are thermally affected by each other, and there arises a problem that it is difficult to respond to a desired temperature requirement for a temperature adjustment target.

An object of the present invention is to cope with such a problem. That is, the object of the present invention is to reduce, in a refrigerant unit including a plurality of heat exchangers corresponding to a plurality of temperature adjustment targets, the heat exchangers having different functions from being thermally affected by each other and to respond to a desired temperature requirement for the temperature adjustment target.

### Solution to Problems

In order to solve such a problem, a refrigerant unit according to one aspect of the present invention has the following configuration.

A refrigerant unit includes a refrigerant circuit and a single support member that collectively supports a component of the refrigerant circuit. The refrigerant circuit includes a first heat exchanger and a second heat exchanger having different functions. The first heat exchanger is disposed between a plurality of the second heat exchangers. A distance from one side of the plurality of second heat exchangers to the first heat exchanger is greater than a distance from the other side of the plurality of second heat exchangers to the first heat exchanger.

### Effects of Invention

In the refrigerant unit having the above-described features and including the plurality of heat exchangers corresponding to the plurality of temperature adjustment targets, it is possible to reduce the heat exchangers having different functions from being thermally affected by each other and to respond to a desired temperature requirement for the temperature adjustment target.

### BRIEF DESCRIPTION OF DRAWINGS

FIG. 1 is a perspective view of a refrigerant unit according to an embodiment of the present invention.

FIG. 2 is a perspective view of the refrigerant unit according to the embodiment of the present invention.

FIG. 3 is an exploded perspective view of the refrigerant unit according to the embodiment of the present invention.

FIG. 4 is a plan view showing a positional relationship between a support member and each heat exchanger as viewed from a second fixing surface side in the refrigerant unit according to the embodiment of the present invention.

FIG. 5 is a plan view of the surfaces of a first channel module and a second channel module applied to the refrigerant unit according to the embodiment of the present invention, on the same plane as that of a first fixing surface.

FIG. 6 is a plan view of the surfaces of the first channel module and the second channel module applied to the refrigerant unit according to the embodiment of the present invention, on the same plane as that of the second fixing surface.

FIG. 7 is a reference diagram showing the flow of refrigerant during a cooling operation in the refrigerant unit according to the embodiment of the present invention.

FIG. 8 is a reference diagram showing the flow of refrigerant during a heating operation in the refrigerant unit according to the embodiment of the present invention.

FIG. 9 is a plan view showing a positional relationship between a support member and each heat exchanger as viewed from a second fixing surface side in a modification of the refrigerant unit according to the embodiment of the present invention.

### DESCRIPTION OF EMBODIMENTS

A mode for carrying out the present invention is described in detail hereinafter with reference to the drawings. In the following description, the same reference signs denote portions of the same functions, and redundant descriptions in the drawings are omitted as appropriate.

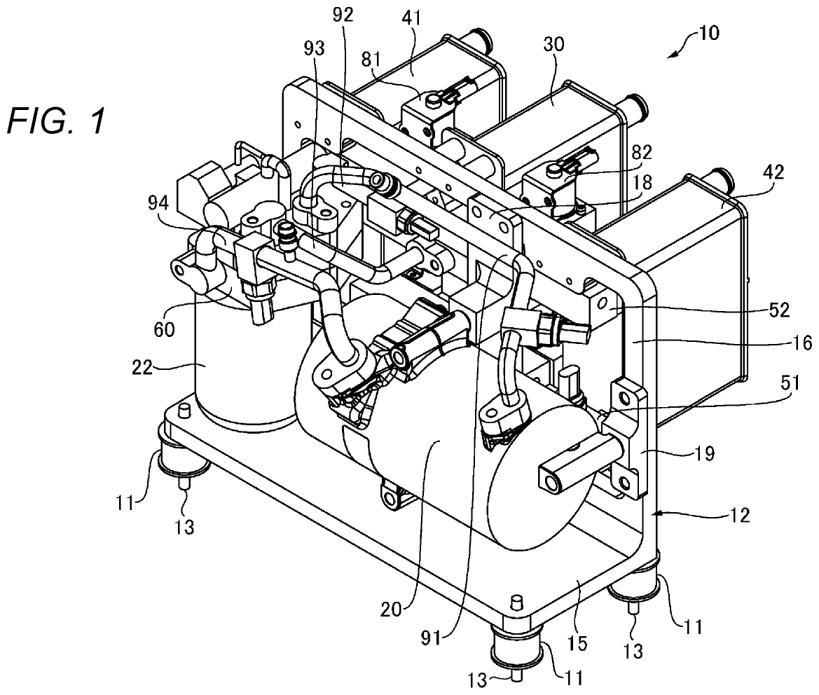

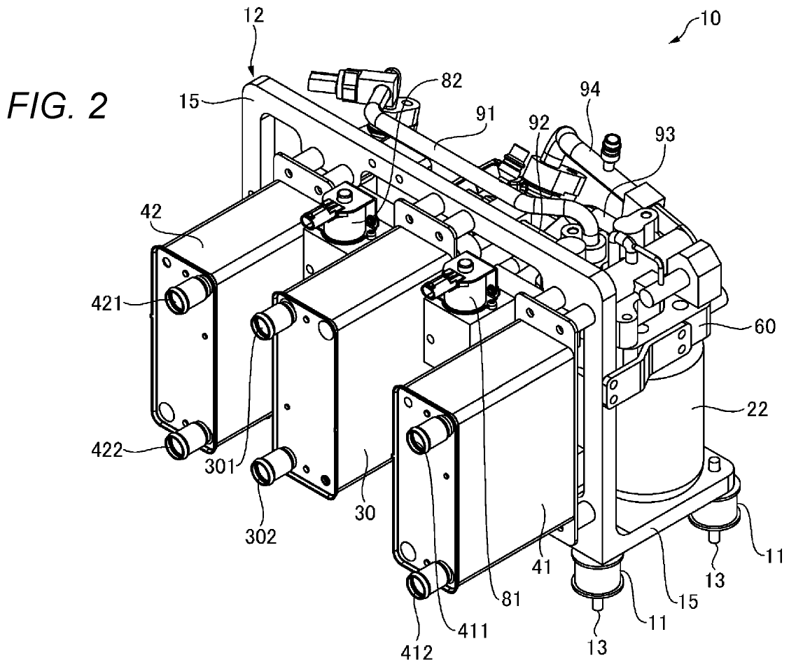

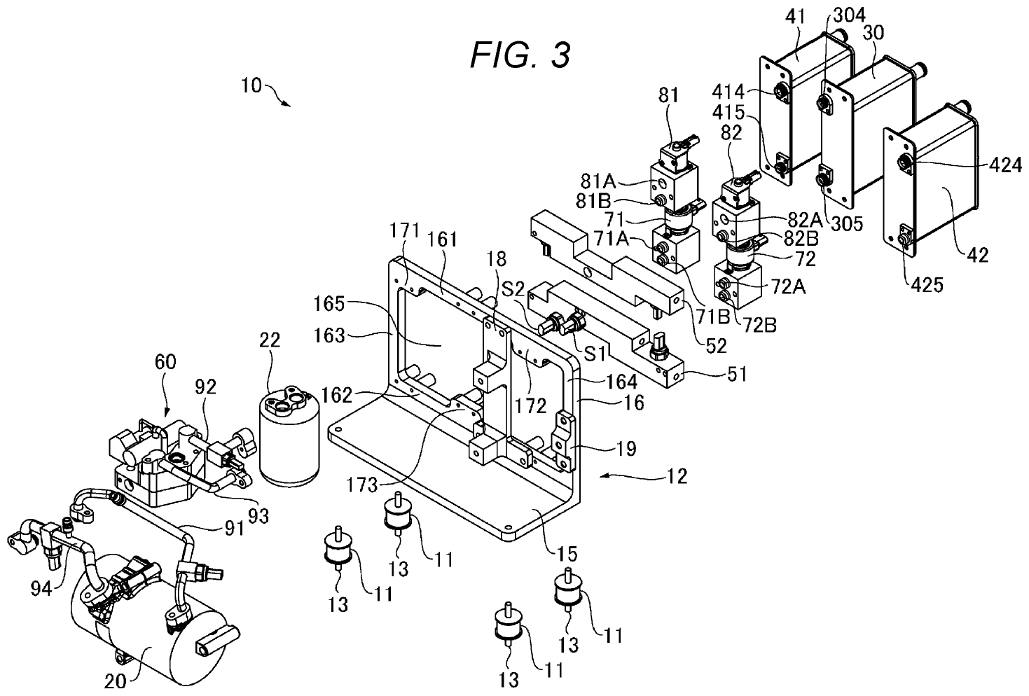

FIGS. 1 and 2 are perspective views of a refrigerant unit 10 according to the present embodiment, and FIG. 3 is an exploded perspective view of the refrigerant unit 10. The refrigerant unit 10 according to the present embodiment is unitized by fixing each component forming a refrigerant circuit to a support member 12, and is used, for example, in an air-conditioning device or a heat management system which is mounted on a vehicle including a battery for traveling and performs air conditioning in a vehicle interior and temperature adjustment of in-vehicle equipment.

As shown in each figure, the refrigerant unit 10 includes the refrigerant circuit in which a compressor 20, an accumulator 22, a first heat exchanger 30, second heat exchangers 41, 42, a first channel module 51, a second channel module 52, a four-way valve 60 as a channel direction switching means, expansion valves 71, 72 as a decompression device, and electromagnetic valves 81, 82 as a channel switching valve are connected through refrigerant pipes 91 to 94, and the support member 12 that collectively supports these components.

As shown in FIGS. 1 to 3, in the refrigerant unit 10, the compressor 20, the accumulator 22, the first heat exchanger 30, and the second heat exchangers 41, 42 forming the refrigerant circuit are fixed to the support member 12. As described later, the four-way valve 60 is fixed to the accumulator 22, the first channel module 51 and the second channel module 52 are fixed to the first heat exchanger 30 and the second heat exchangers 41, 42, the expansion valves 71, 72 are fixed to the first channel module 51, and the electromagnetic valves 81, 82 are fixed to the second channel module 52. Thus, these components are indirectly fixed to the support member 12.

### Positional Relationship of Components

FIG. 1 is the perspective view from the side closer to the compressor 20 and the accumulator 22, FIG. 2 is the perspective view from the side closer to the first heat exchanger 30 and the second heat exchangers 41, 42, and FIG. 3 is the exploded perspective view from the compressor 20 side.

The support member 12 has a bottom plate portion 15 which is a substantially rectangular plate-like member, and a substantially rectangular frame portion 16 which is formed integrally with the bottom plate portion 15 and is provided perpendicularly to the bottom plate portion 15 on one end side of the bottom plate portion 15. The support member 12 has a sufficient width with which the compressor 20 and the accumulator 22 can be disposed and the refrigerant pipes do not interfere with each component included in the refrigerant unit 10.

Of the bottom plate portion 15, a surface (front surface) on which the frame portion 16 is provided is a fixing surface to which the components of the refrigerant circuit are fixed, and a surface (back surface) opposite to the frame portion 16 is an attachment surface for attaching the refrigerant unit 10 to a vehicle body or the like. By fastening the four corners of the back surface of the bottom plate portion 15 with fasteners 13 through rubber bushes 11, the refrigerant unit 10 can be attached to an attachment target such as the vehicle body.

The frame portion 16 has a pair of horizontal portions 161,162 parallel with the bottom plate portion 15, a pair of vertical portions 163, 164 perpendicular to the bottom plate portion 15, and a space 165 formed between the horizontal portions 161,162 and the vertical portions 163,164.

Both surfaces of the frame portion 16 are fixing surfaces to which the components of the refrigerant circuit are fixed. In particular, of the frame portion 16, a surface (surface on one side) opposite to the surface on which the bottom plate portion 15 is provided is a first fixing surface to which the first heat exchanger 30 and the second heat exchangers 41, 42 are fixed, and a surface (surface on the other side) on the same side as the surface on which the bottom plate portion 15 is provided is a second fixing surface to which the compressor 20 and the accumulator 22 are fixed.

The frame portion 16 is provided with fixing pieces 171,172 to which the second heat exchangers 41, 42 are fixed on one end side and the other end side of the horizontal portion 161 located on the upper side in the vertical direction, and is provided with a fixing piece 173 to which the first heat exchanger 30 is fixed at a center portion of the horizontal portion 162 located on the lower side in the vertical direction.

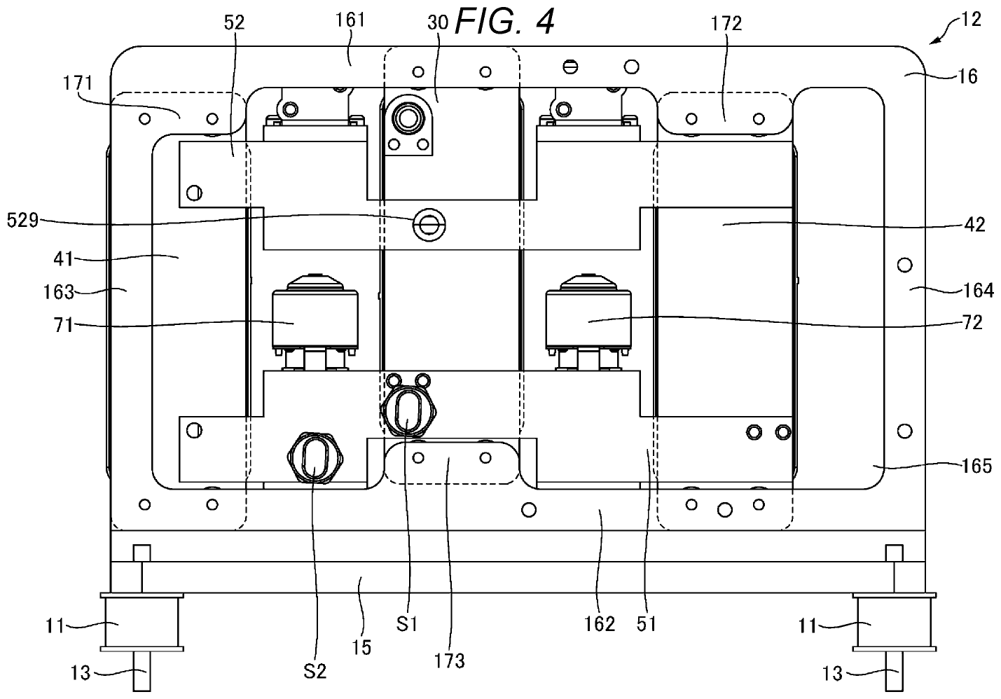

FIG. 4 is a plan view showing a positional relationship between the support member 12, the first heat exchanger 30, and the second heat exchangers 41, 42 as viewed from the second fixing surface side. As shown in FIG. 4, the first heat exchanger 30 is fixed to the first fixing surface of the frame portion 16 with the horizontal portion 161 and the fixing piece 173, the second heat exchanger 41 is fixed to the first fixing surface with the horizontal portion 162 and the fixing piece 171, and the second heat exchanger 42 is fixed to the first fixing surface with the horizontal portion 162 and the fixing piece 172.

Accordingly, on the first fixing surface, the first heat exchanger 30 and the second heat exchangers 41, 42 are bridged between the horizontal portion 161 and the horizontal portion 162 across the space 165. Moreover, on the first fixing surface, the second heat exchanger 41, the first heat exchanger 30, and the second heat exchanger 42 are provided side by side in the horizontal direction so as to be parallel with and separated from each other.

In the example of FIGS. 1 to 4, the first heat exchanger 30 is disposed between the second heat exchangers 41, 42, and the first heat exchanger 30 and the second heat exchangers 41, 42 are disposed at equal intervals.

As described above, by fixing the first heat exchanger 30 and the second heat exchangers 41, 42 such that these heat exchangers are bridged between the horizontal portion 161 and the horizontal portion 162 to function as beams, it is possible to ensure the space 165 while improving the strength of the support member 12 and to reduce the weight of the support member 12 and improve the strength of the support member 12.

Note that a fixing position at which the first heat exchanger 30 is fixed to the first fixing surface is different in the vertical direction from fixing positions at which the second heat exchangers 41, 42 are fixed to the first fixing surface. In the present embodiment, the first heat exchanger 30 is fixed to the first fixing surface so as to be positioned slightly higher than the second heat exchangers 41, 42 in the vertical direction.

The first channel module 51 and the second channel module 52 are fixed to the first heat exchanger 30 and the second heat exchangers 41, 42. The first channel module 51 and the second channel module 52 are arranged in the space 165 of the frame portion 16 when the first heat exchanger 30 and the second heat exchangers 41, 42 are fixed to the second fixing surface. Note that in the space 165, the first channel module 51 is disposed on the lower side in the vertical direction, and the second channel module 52 is disposed on the upper side in the vertical direction.

Note that the first channel module 51 and the second channel module 52 are fixed not only to the first heat exchanger 30 and the second heat exchangers 41, 42, but also fixed in various forms. For example, at least part of the first channel module 51 and the second channel module 52 may be fixed to the frame portion 16 with a fixing member such as a bracket. Alternatively, flanges may be formed on the first channel module 51 and the second channel module 52, and by fastening the flanges, the first channel module 51 and the second channel module 52 may be directly fixed to the frame portion 16.

In this manner, the first channel module 51 and the second channel module 52 can be firmly fixed to the support member 12, which can prevent the first channel module 51 and the second channel module 52 from dropping from the support member 12 and therefore the refrigerant unit 10. Note that the fixing member or the flange is formed of a heat insulating member so that heat transfer from the first channel module 51 and the second channel module 52 to the fixing member or the support member 12 can be prevented.

The expansion valves 71, 72 provided in a refrigerant channel (described later) formed inside the first channel module 51 are fixed to the first channel module 51.

The electromagnetic valves 81, 82 provided in a refrigerant channel (described later) formed inside the second channel module 52 are fixed to the second channel module 52. In the space 165 of the frame portion 16, the expansion valve 71 and the electromagnetic valve 81 are disposed between the first heat exchanger 30 and the second heat exchanger 41, and the expansion valve 72 and the electromagnetic valve 82 are disposed between the first heat exchanger 30 and the second heat exchanger 42.

On the second fixing surface of the frame portion 16, a beam-like member 18 is fixed so as to be bridged between the horizontal portion 161 and the horizontal portion 162 across the space 165. A bracket 19 for fixing the compressor 20 is fixed to one vertical portion 164 on the second fixing surface. With the beam-like member 18, the strength of the support member 12 can be improved.

The compressor 20 and the accumulator 22 are fixed to the second fixing surface of the frame portion 16. Specifically, the compressor 20 is fixed to the second fixing surface with the beam-like member 18 and the bracket 19 in a state of being separated from the bottom plate portion 15. The accumulator 22 is placed on the bottom plate portion 15, and is fixed to the second fixing surface with a bracket (not shown).

### First Heat Exchanger 30 and Second Heat Exchangers 41, 42

The first heat exchanger 30 and the second heat exchangers 41, 42 are refrigerant-heat medium heat exchangers that exchange heat between refrigerant and a heat medium (for example, water), and perform air conditioning in the vehicle interior, temperature adjustment of the in-vehicle equipment, and the like by supplying heat of the refrigerant to a temperature adjustment target via a heat medium circuit (not shown).

The first heat exchanger 30 is provided with a pair of refrigerant ports 304, 305 serving as a refrigerant inlet or a refrigerant outlet according to a refrigerant circulation direction. Similarly, the second heat exchanger 41 is provided with a pair of refrigerant ports 414, 415 serving as a refrigerant inlet or a refrigerant outlet according to the refrigerant circulation direction, and the second heat exchanger 42 is provided with a pair of refrigerant ports 424, 425 serving as a refrigerant inlet or a refrigerant outlet according to the refrigerant circulation direction.

In the refrigerant unit 10 according to the present embodiment, the refrigerant circulation direction can be switched by the four-way valve 60, and the first heat exchanger 30 and the second heat exchangers 41, 42 function as an evaporator or a condenser according to the refrigerant circulation direction. At this time, the first heat exchanger 30 and the second heat exchangers 41, 42 have different functions.

That is, in the refrigerant unit 10, by controlling the four-way valve 60 to switch the refrigerant circulation direction, the refrigerant can be caused to flow such that the first heat exchanger 30 functions as the condenser and the second heat exchangers 41, 42 function as the evaporator, or the first heat exchanger 30 functions as the evaporator and the second heat exchangers 41, 42 function as the condenser.

As shown in FIG. 2, heat medium pipes 301, 302 into which the heat medium circulating in the heat medium circuit flows or from which the heat medium flows out are connected to the first heat exchanger 30, heat medium pipes 411, 412 into which the heat medium circulating in the heat medium circuit flows or from which the heat medium flows out are connected to the second heat exchanger 41, and heat medium pipes 421, 422 into which the heat medium circulating in the heat medium circuit flows or from which the heat medium flows out are connected to the second heat exchanger 42.

The heat medium circulating in the heat medium circuit flows into the first heat exchanger 30 from one of the heat medium pipe 301 or the heat medium pipe 302, exchanges heat with the refrigerant in the first heat exchanger 30, and flows out to the other one of the heat medium pipe 302 or the heat medium pipe 301.

Similarly, the heat medium circulating in the heat medium circuit flows into the second heat exchanger 41 from one of the heat medium pipe 411 or the heat medium pipe 412, exchanges heat with the refrigerant in the second heat exchanger 41, and flows out to the other one of the heat medium pipe 412 or the heat medium pipe 411.

The heat medium circulating in the heat medium circuit flows into the second heat exchanger 42 from one of the heat medium pipe 421 or the heat medium pipe 422, exchanges heat with the refrigerant in the second heat exchanger 42, and flows out to the other one of the heat medium pipe 422 or the heat medium pipe 421.

### First Channel Module 51 and Second Channel Module 52

Next, the first channel module 51 and the second channel module 5 will be described.

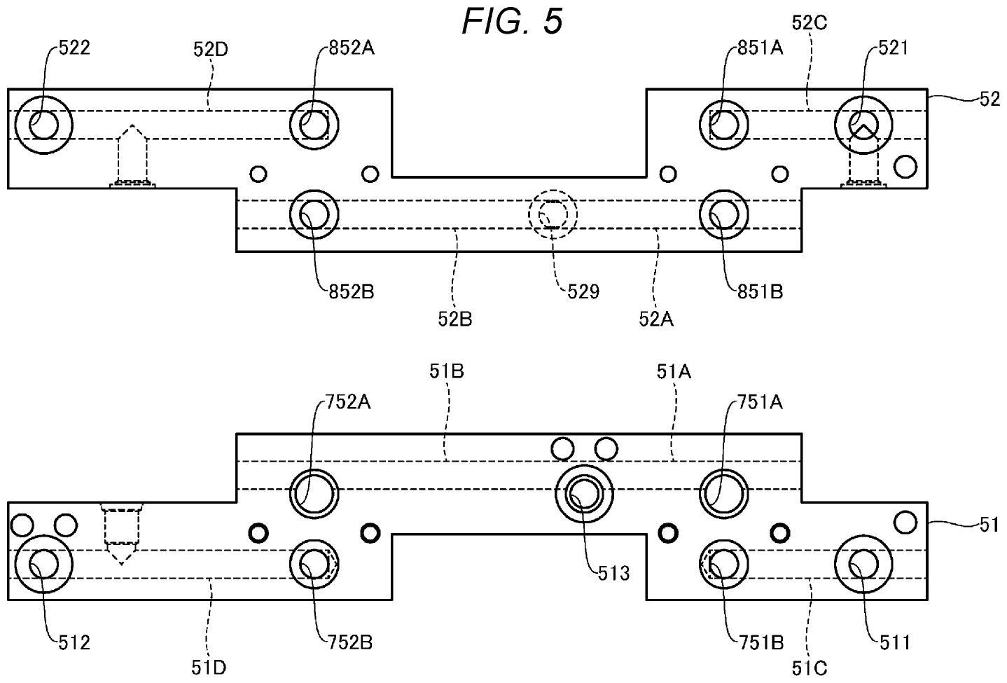

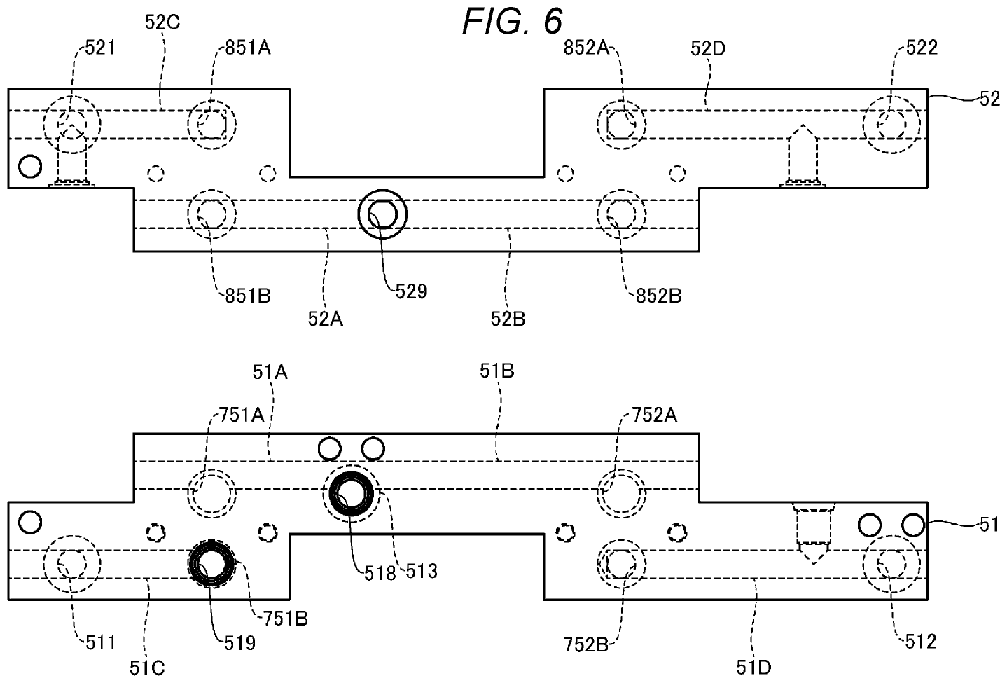

FIGS. 5 and 6 show plan views of the first channel module 51 and the second channel module 52. FIG. 5 is a plan view of the surfaces of the first channel module 51 and the second channel module 52 on the same plane as that of the first fixing surface, and FIG. 6 is a plan view of the surfaces of the first channel module 51 and the second channel module 52 on the same plane as that of the second fixing surface.

The first channel module 51 and the second channel module 52 have, for example, a manifold structure in which a plurality of refrigerant channels is integrally formed inside a block body made of metal such as aluminum, and at least part of the refrigerant channel in the refrigerant circuit is configured as an integrated component.

As shown in FIG. 5, the first channel module 51 is provided with connection portions 511, 512, 513, 751A, 751B, 752A, 752B for connecting other components and the first channel module 51 to allow the refrigerant to flow therebetween on the same plane on the first fixing surface side. As shown in FIG. 6, the first channel module 51 is provided with, on the same plane on the second fixing surface side, attachment portions 518, 519 to which detection devices S1, S2 that detect the state of the refrigerant circulating in the refrigerant unit 10 are attached.

Each connection portion is provided corresponding to the position of the refrigerant port of the device to which the first channel module 51 is connected. Specifically, the connection portion 511 is provided at a position corresponding to the refrigerant port 415 of the second heat exchanger 41, the connection portion 512 is provided at a position corresponding to the refrigerant port 425 of the second heat exchanger 42, and the connection portion 513 is provided at a position corresponding to the refrigerant port 305 of the first heat exchanger 30.

In the first channel module 51, the connection portion 751A between a refrigerant channel 51A connected to the expansion valve 71 and the first heat exchanger 30 is disposed so as to be shifted in the vertical direction from the connection portion 751B between a refrigerant channel 51C connected to the expansion valve 71 and the second heat exchanger 41. A pair of the connection portions 751A, 751B is provided at positions corresponding to a pair of refrigerant ports (refrigerant inlet or refrigerant outlet) 71A, 71B of the expansion valve 71.

Similarly, in the first channel module 51, the connection portion 752A between a refrigerant channel 51B connected to the expansion valve 72 and the first heat exchanger 30 is disposed so as to be shifted in the vertical direction from the connection portion 752B between a refrigerant channel 52D connected to the expansion valve 72 and the second heat exchanger 42. A pair of the connection portions 752A, 752B is provided at positions corresponding to a pair of refrigerant ports 72A, 72B of the expansion valve 72.

In this manner, by providing the connection portions 751A, 751B, 752A, 752B in the first channel module 51 to connect the expansion valves 71, 72, attachment and detachment of the expansion valves 71, 72 are facilitated, and maintainability is improved.

Note that as shown in FIG. 3, the pair of refrigerant ports 71A, 71B of the expansion valve 71 is disposed at different heights in the vertical direction. According to the refrigerant circulation direction, one of the refrigerant ports serves as the refrigerant inlet, and the other refrigerant port serves as the refrigerant outlet. Similarly, the pair of refrigerant ports 72A, 72B of the expansion valve 72 is disposed at different heights in the vertical direction, and according to the refrigerant circulation direction, one of the refrigerant ports serves as the refrigerant inlet and the other refrigerant port serves as the refrigerant outlet.

In the first channel module 51, the refrigerant channel 51A causing the connection portion 513 and the connection portion 751A to communicate with each other, the refrigerant channel 51B causing the connection portion 513 and the connection portion 752A to communicate with each other, the refrigerant channel 51C causing the connection portion 751B and the connection portion 511 to communicate with each other, and a refrigerant channel 51D causing the connection portion 752B and the connection portion 512 to communicate with each other are formed. The connection portion 513 is a branch point or junction point of the refrigerant channel 51A and the refrigerant channel 51B.

In the first channel module 51, the connection portions 513, 751A, 752A are disposed at the substantially same height in the vertical direction. Further, the connection portions 511, 512, 751B, 752B are disposed at the substantially same height in the vertical direction, and are located lower than the connection portions 513, 751A, 752A in the vertical direction.

Thus, the refrigerant channels 51A to 51D are arranged substantially in parallel, and the refrigerant channels 51A, 51B are located higher than the refrigerant channels 51C, 51D in the vertical direction.

The attachment portion 518 is disposed on the back side of the connection portion 513, and the attachment portion 519 is disposed on the back side of the connection portion 751B. Thus, the detection devices S1, S2 are attached to the surface of the first channel module 51 opposite to the surface to which the first heat exchanger 30 and the second heat exchangers 41, 42 are connected.

The detection device SI attached to the attachment portion 518 is provided at the branch point or junction point between the refrigerant channel 51 A and the refrigerant channel 51B, and the detection device S2 attached to the attachment portion 519 is provided at a connection point between the refrigerant channel 51C and the expansion valve 71. That is, the detection device SI is provided at the branch point or junction point of the refrigerant channel formed by the refrigerant channel 51A and the refrigerant channel 51B and connecting the first heat exchanger 30 and the second heat exchangers 41, 42, and the detection device S2 is provided near such a branch point or junction point.

Since the detection device S1 or the detection device S2 can detect the state of the refrigerant such as the temperature or pressure of the refrigerant immediately before flowing out of the first heat exchanger 30 and diverted to the second heat exchangers 41, 42, it is not necessary to provide the detection devices for the second heat exchangers 41, 42, and the number of detection devices can be reduced in the refrigerant unit 10. That is, by optimizing the arrangement position of the detection device SI or the detection device S2, the state of the refrigerant can be efficiently detected. Note that the detection results of the detection devices S1, S2 are output to a control device (not shown) and the refrigerant circuit is controlled according to the detection results.

The second channel module 52 is provided with connection portions 521, 522, 851A, 851B, 852A, 852B for connecting other components and the second channel module 52 to allow the refrigerant to flow therebetween on the same plane on the first fixing surface side. The second channel module 52 is provided with a connection portion 529 connected to a refrigerant pipe 93 on the second fixing surface side.

Each connection portion is provided corresponding to the position of the refrigerant port of the device to which the second channel module 52 is connected.

Specifically, the connection portion 521 is provided at a position corresponding to the refrigerant port 414 of the second heat exchanger 41, and the connection portion 522 is provided at a position corresponding to the refrigerant port 424 of the second heat exchanger 42.

A pair of the connection portions 851A, 851B is provided at positions corresponding to a pair of refrigerant ports (refrigerant inlet or refrigerant outlet) 81A, 81B of the electromagnetic valve 81, and a pair of the connection portions 852A, 852B is provided at positions corresponding to a pair of refrigerant ports (refrigerant inlet or refrigerant outlet) 82A, 82B of the electromagnetic valve 82. In this manner, by providing the connection portions 851A, 851B, 852A, 852B in the second channel module 52 to connect the electromagnetic valves 81, 82, attachment and detachment of the electromagnetic valves 81, 82 are facilitated, and the maintainability is improved.

Note that as shown in FIG. 3, the pair of refrigerant ports 81A, 81B of the electromagnetic valve 81 is disposed at different heights in the vertical direction, and according to the refrigerant circulation direction, one of the refrigerant ports serves as the refrigerant inlet and the other refrigerant port serves as the refrigerant outlet. Similarly, the pair of refrigerant ports 82A, 82B of the electromagnetic valve 82 is disposed at different heights in the vertical direction, and according to the refrigerant circulation direction, one of the refrigerant ports serves as the refrigerant inlet and the other refrigerant port serves as the refrigerant outlet.

In the second channel module 52, a refrigerant channel 52A causing the connection portion 529 and the connection portion 851B to communicate with each other, a refrigerant channel 52B causing the connection portion 529 and the connection portion 852B to communicate with each other, a refrigerant channel 52C causing the connection portion 851 A and the connection portion 521 to communicate with each other, and a refrigerant channel 52D causing the connection portion 852A and the connection portion 522 to communicate with each other are formed. The connection portion 529 is a branch point or junction point of the refrigerant channel 52A and the refrigerant channel 52B.

In the second channel module 52, the connection portions 529, 851B, 852B are disposed at the substantially same height in the vertical direction. Further, the connection portions 521, 522, 851A, 852A are disposed at the substantially same height in the vertical direction, and are located higher than the connection portions 529, 851B, 852B in the vertical direction.

Thus, the refrigerant channels 52A to 52D are arranged substantially in parallel, and the refrigerant channels 52C, 52D are located higher than the refrigerant channels 52A, 52B in the vertical direction.

### Connection Relationship Between Components of Refrigerant Circuit

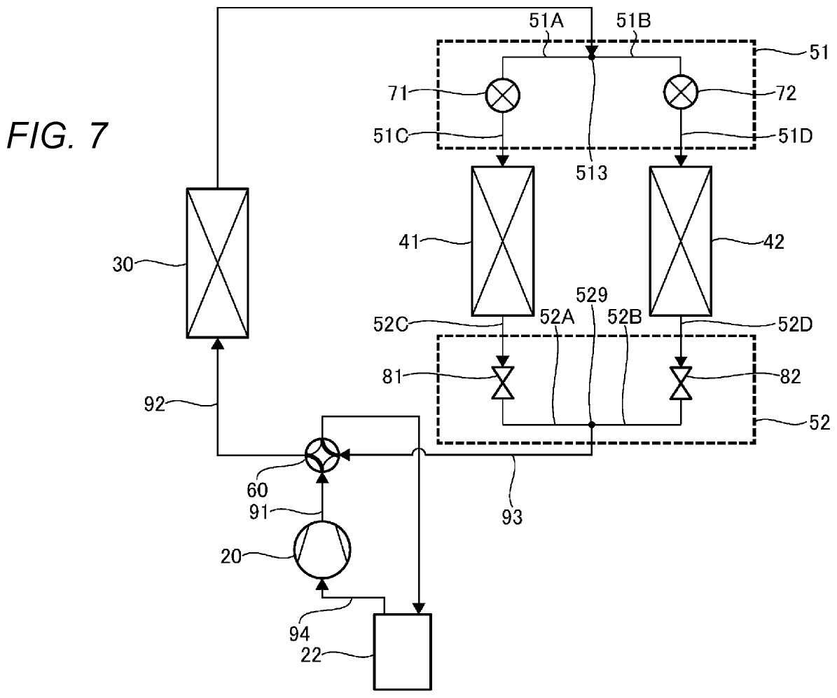

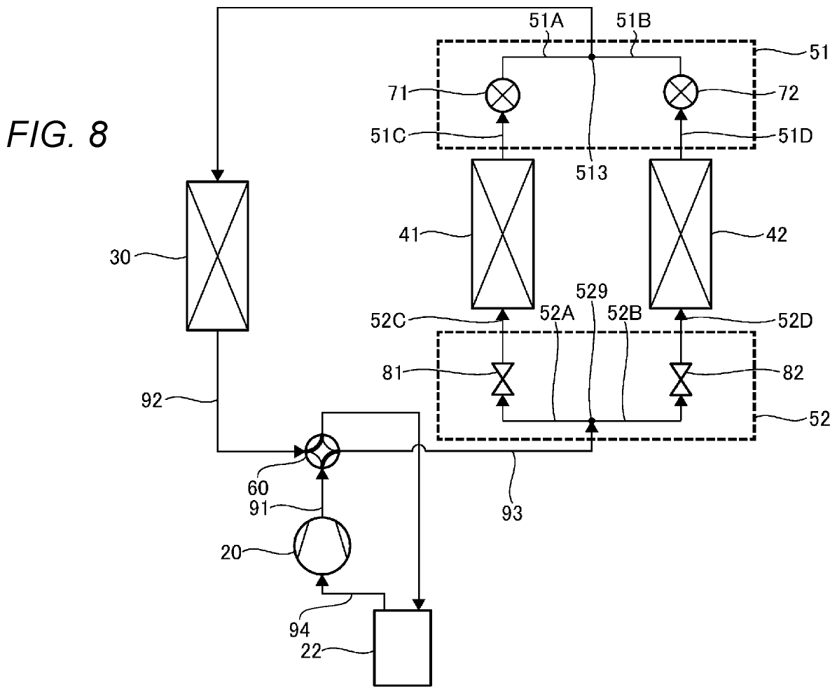

In the refrigerant unit 10, the components of the refrigerant circuit are connected as follows (see FIGS. 7 and 8). The refrigerant suction port of the compressor 20 is connected to the accumulator 22 via the four-way valve 60 by the refrigerant pipe 94, and the refrigerant discharge port of the compressor 20 is connected to the four-way valve 60 by the refrigerant pipe 91. Moreover, the four-way valve 60 is connected to the first heat exchanger 30 by the refrigerant pipe 92, and is connected to the connection portion 529 of the second channel module 52 by the refrigerant pipe 93. The refrigerant pipe 93 is connected to the connection portion 529 of the second channel module 52, and accordingly, the refrigerant pipe 93 and the refrigerant channels 52A, 52B communicate with each other and the refrigerant flows therebetween.

In the first channel module 51, the connection portion 511 is connected to the refrigerant port 415 of the second heat exchanger 41, the connection portion 512 is connected to the refrigerant port 425 of the second heat exchanger 42, and the connection portion 513 is connected to the refrigerant port 305 of the first heat exchanger 30. Moreover, the connection portions 751A, 751B are connected to the refrigerant ports 71A, 71B of the expansion valve 71, respectively. Similarly, the connection portions 752A, 752B are connected to the refrigerant ports 72A, 72B of the expansion valve 72, respectively.

Accordingly, in the first channel module 51, the connection portion 511 and the connection portion 513 communicate with each other via the refrigerant channel 51A, the expansion valve 71, and the refrigerant channel 51C, and the refrigerant channel connecting the first heat exchanger 30 and the second heat exchanger 41 is formed. Moreover, in the first channel module 51, the connection portion 513 and the connection portion 512 communicate with each other via the refrigerant channel 51B, the expansion valve 72, and the refrigerant channel 51D, and the refrigerant channel connecting the first heat exchanger 30 and the second heat exchanger 42 is formed.

Note that in order to reduce a difference in capability between the heat exchangers due to channel resistance, it is preferable that the first heat exchanger 30 is disposed between the second heat exchangers 41, 42 such that a distance between the first heat exchanger 30 and the second heat exchanger 41 and a distance between the first heat exchanger 30 and the second heat exchanger 42 are substantially equal to each other and the length of the refrigerant channel connecting the first heat exchanger 30 and the second heat exchanger 41 is equal to the length of the refrigerant channel connecting the first heat exchanger 30 and the second heat exchanger 42. By making a difference in channel length between the refrigerant channel on one side and the refrigerant channel on the other side as small as possible, a difference in channel resistance between these two channels can be reduced, and the difference in capability between the two second heat exchangers 41, 42 can be reduced.

As described above, in the expansion valves 71, 72, the refrigerant ports are arranged side by side in the vertical direction. Thus, the channel formed in the first channel module 51 and connecting the first heat exchanger 30 and the second heat exchanger 41 includes the refrigerant channel 51A and the refrigerant channel 51C disposed in the horizontal direction, and the channel formed in the vertical direction between these channels by the expansion valve 71. That is, a step portion is formed between the refrigerant channel 51A and the refrigerant channel 51C.

Similarly, the channel formed in the first channel module 51 and connecting the first heat exchanger 30 and the second heat exchanger 42 includes the refrigerant channel 51B and the refrigerant channel 51D disposed in the horizontal direction, and the channel formed in the vertical direction between these channels by the expansion valve 72. That is, a step portion is formed between the refrigerant channel 51B and the refrigerant channel 51D.

Thus, the refrigerant flowing through the refrigerant channel 51A, the expansion valve 71, and the refrigerant channel 51C is changed its refrigerant channel direction by the step portion, and the refrigerant flowing through the refrigerant channel 51B, the expansion valve 72, and the refrigerant channel 51D is changed its refrigerant channel direction by the step portion.

That is, the first channel module 51 includes the horizontal refrigerant channel 51A and refrigerant channel 51C and the refrigerant channel in the vertical direction inside the expansion valve 71. The channel direction is changed such that the refrigerant flowing horizontally flows in the vertical direction, and then, the channel direction is changed again such that the refrigerant flows in the horizontal direction. Moreover, the first channel module 51 includes the horizontal refrigerant channel 51B and refrigerant channel 51D and the refrigerant channel in the vertical direction inside the expansion valve 72. The channel direction is changed such that the refrigerant flowing horizontally flows in the vertical direction, and then, the channel direction is changed again such that the refrigerant flows in the horizontal direction.

As described above, in the first channel module 51, both the refrigerant channel connecting the first heat exchanger 30 and the second heat exchanger 41 and the refrigerant channel connecting the first heat exchanger 30 and the second heat exchanger 42 are formed such that the channel direction is changed twice. As described above, by equalizing the number of times of change in the channel direction between the refrigerant channel connecting the first heat exchanger 30 and the second heat exchanger 41 and the refrigerant channel connecting the first heat exchanger 30 and the second heat exchanger 42, it is possible to reduce the difference in capability between the heat exchangers due to the channel resistance.

In the second channel module 52, the connection portion 521 is connected to the refrigerant port 414 of the second heat exchanger 41, and the connection portion 522 is connected to the refrigerant port 424 of the second heat exchanger 42. Moreover, the connection portions 851A, 851B are connected to the refrigerant ports 81A, 81B of the electromagnetic valve 81, respectively. Similarly, the connection portions 852A, 852B are connected to the refrigerant ports 82A, 82B of the electromagnetic valve 82, respectively.

Accordingly, in the second channel module 52, the connection portion 521 and the connection portion 529 communicate with each other via the refrigerant channel 52C, the electromagnetic valve 81, and the refrigerant channel 52A, and the refrigerant channel connecting the second heat exchanger 41 and the four-way valve 60 is formed by these channels and the refrigerant pipe 93. Moreover, in the second channel module 52, the connection portion 522 and the connection portion 529 communicate with each other via the refrigerant channel 52D, the electromagnetic valve 82, and the refrigerant channel 52B, and the refrigerant channel connecting the second beat exchanger 42 and the four-way valve 60 is formed by these channels and the refrigerant pipe 93.

### Flow of Refrigerant

Next, circulation of the refrigerant in the refrigerant unit 10 as described above will be described with reference to FIGS. 7 and 8. In the refrigerant unit 10, for example, the refrigerant circulation direction can be switched by the four-way valve 60 according to an air-conditioning purpose or the temperature adjustment target.

### (1) Flow of Refrigerant During Cooling Operation

For example, in a case where a cooling operation is performed in the air-conditioning device using the refrigerant unit 10, the refrigerant circulates as follows (see FIG. 7). That is, the refrigerant is compressed by the compressor 20 and discharged as high-pressure gas refrigerant, flows through the refrigerant pipe 91, and flows into the four-way valve 60. The high-pressure gas refrigerant flows through the refrigerant pipe 92 from the four-way valve, and flows into the first heat exchanger 30.

The refrigerant having flowed into the first heat exchanger 30 dissipates heat by exchanging heat with another heat medium in the first heat exchanger 30, then flows out of the first heat exchanger 30 and flows into the first channel module 51, branches at the connection portion 513 of the first channel module 51, and is substantially equally divided into the refrigerant channel 51A and the refrigerant channel 51B.

The refrigerant flowing through the refrigerant channel 51A is decompressed and expanded by the expansion valve 71, turns into low-pressure refrigerant, and flows into the second heat exchanger 41. Meanwhile, the refrigerant flowing through the refrigerant channel 51B is decompressed and expanded by the expansion valve 72, turns into low-pressure refrigerant, and flows into the second heat exchanger 42.

The low-pressure refrigerant having flowed into the second heat exchangers 41, 42 absorbs heat by exchanging heat with another heat medium in the second heat exchangers 41, 42, and then flows out of the second heat exchangers 41, 42.

The refrigerant having flowed out of the second heat exchanger 41 passes through the electromagnetic valve 81 while flowing through the refrigerant channel 52A of the second channel module 52, joins the refrigerant having flowed through the refrigerant channel 52B at the connection portion 529, and flows to the refrigerant pipe 93.

Similarly, the refrigerant having flowed out of the second heat exchanger 42 passes through the electromagnetic valve 82 while flowing through the refrigerant channel 52B of the second channel module 52, joins the refrigerant having flowed through the refrigerant channel 52A at the connection portion 529, and flows to the refrigerant pipe 93.

The refrigerant having flowed from the second channel module 52 into the refrigerant pipe 93 again enters the four-way valve 60, flows into the accumulator 22 via the four-way valve 60, and returns from the accumulator 22 to the compressor 20 via the four-way valve 60. The refrigerant having flowed into the compressor 20 is compressed again, and the above-described circulation is repeated.

(2) Flow of Refrigerant During Heating Operation For example, in a case where a heating operation is performed in the air-conditioning device using the refrigerant unit 10, the refrigerant circulates as follows (see FIG. 8). That is, the refrigerant is compressed by the compressor 20 and discharged as high-pressure gas refrigerant, flows through the refrigerant pipe 91, and flows into the four-way valve 60. The high-pressure gas refrigerant flows through the refrigerant pipe 93 from the four-way valve, branches at the connection portion 529 of the second channel module 52, and is substantially equally divided into the refrigerant channel 52A and the refrigerant channel 52B.

The refrigerant having flowed through the refrigerant channel 52A flows into the second heat exchanger 41 through the electromagnetic valve 81, dissipates heat by exchanging heat with another heat medium in the second heat exchanger 41, and then flows out of the second heat exchanger 41 and flows into the refrigerant channel 51A of the first channel module 51. The refrigerant flowing through the refrigerant channel 51A is decompressed and expanded in the expansion valve 71, tums into low-pressure refrigerant, joins the refrigerant having flowed through the refrigerant channel 51B at the connection portion 513 of the first channel module 51, and flows into the first heat exchanger 30.

The refrigerant having flowed through the refrigerant channel 52B flows into the second heat exchanger 42 through the electromagnetic valve 82, dissipates heat by exchanging heat with another heat medium in the second heat exchanger 42, and then flows out of the second heat exchanger 42 and flows into the refrigerant channel 51B of the first channel module 51. The refrigerant flowing through the refrigerant channel 51B is decompressed and expanded in the expansion valve 72, turns into low-pressure refrigerant, joins the refrigerant having flowed through the refrigerant channel 51A at the connection portion 513 of the first channel module 51, and flows into the first heat exchanger 30.

The refrigerant having flowed into the first heat exchanger 30 absorbs heat by exchanging heat with another heat medium in the first heat exchanger 30, then flows out of the first heat exchanger 30, flows through the refrigerant pipe 92, flows into the accumulator 22 through the four-way valve 60, and returns to the compressor 20 via the four-way valve 60. The refrigerant having flowed into the compressor 20 is compressed again, and the above-described circulation is repeated.

### Modification

In the heat management system to which the refrigerant unit 10 is applied, temperature adjustment is performed on various temperature adjustment targets such as air conditioning in the vehicle interior and plural pieces of in-vehicle equipment according to a temperature requirement. As described above, since the first beat exchanger 30 and the second heat exchangers 41, 42 have different functions, in a case where these heat exchangers are disposed close to each other, the heat exchangers are affected by each other.

In a case where the first heat exchanger 30 and the second heat exchangers 41, 42 have the same heat exchange rate and the second heat exchangers 41, 42 are disposed at equal intervals with respect to the first heat exchanger 30 as in the refrigerant unit 10 according to the above-described embodiment, the first heat exchanger 30 is substantially equally affected by the second heat exchangers 41, 42, and similarly, the second heat exchangers 41, 42 are substantially equally affected by the first heat exchanger 30.

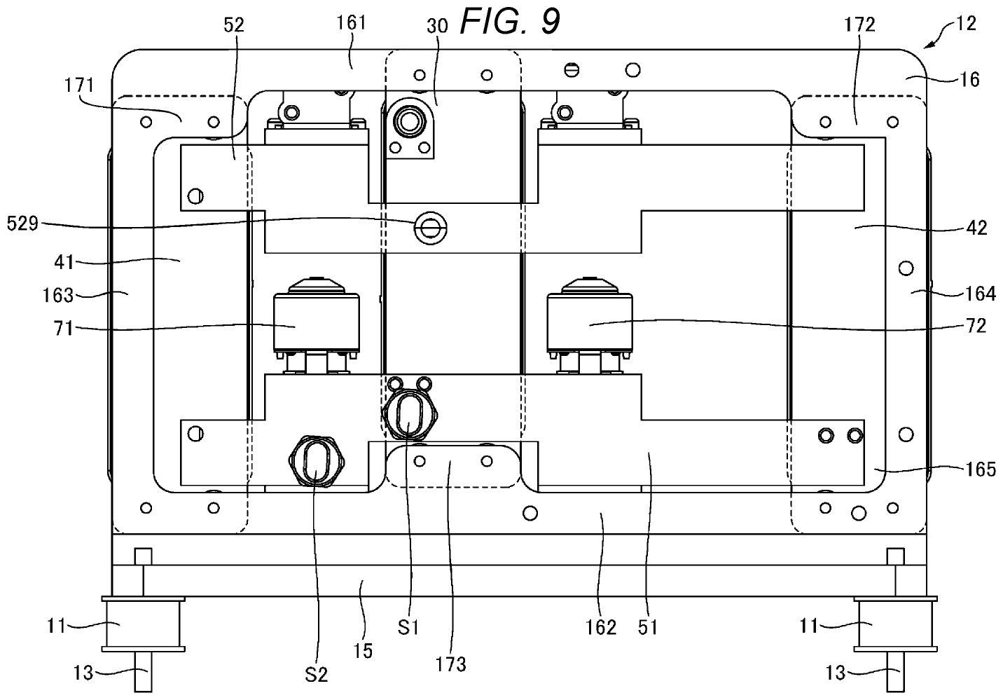

Thus, in the refrigerant unit 10 according to the modification of the present embodiment, as shown in FIG. 9, the second heat exchangers 41, 42 are disposed at different intervals with respect to the first heat exchanger 30. Specifically, the first heat exchanger 30 is disposed between the second heat exchangers 41, 42, and is disposed with a longer distance from the second heat exchanger 42 than a distance from the second heat exchanger 41.

In this manner, the influence of the first heat exchanger 30 on the second heat exchanger 42 can be reduced more than the influence of the first heat exchanger 30 on the second heat exchanger 41. Thus, even in a case where all the first heat exchanger 30 and the second heat exchangers 41, 42 have the same heat exchange rate, the second heat exchanger 42 can be used for a temperature adjustment target having a higher temperature requirement than that of the second heat exchanger 41. Thus, the refrigerant unit 10 can respond to a desired temperature requirement according to a temperature adjustment target. Note that the first heat exchanger 30 and the second heat exchangers 41, 42 have the same heat exchange rate, i.e., common components (parts) are used, so that a manufacturing cost can be reduced.

As described above, the refrigerant unit 10 according to the present embodiment and the modification thereof is unitized by directly or indirectly fixing the components of the refrigerant circuit to the support member 12. Thus, since the distance between the components included in the refrigerant unit 10 are made closer and the lengths of the refrigerant pipes 91 to 94 can be minimized, a heat loss and a refrigerant pressure loss in the refrigerant pipes 91 to 94 can be reduced.

In addition, since the support member 12 and the first channel module 51 and the second channel module 52, which are the components of the refrigerant circuit, are formed of separate and independent components, it is possible to reduce transfer of heat caused by the high-pressure refrigerant flowing through any one of the first channel module 51 or the second channel module 52 to the support member 12 or the other one of the first channel module 51 or the second channel module 52.

More specifically, even in a case where the refrigerant circulation direction is changed, the refrigerant in different temperature zones flows through the first channel module 51 and the second channel module 52, and the high-pressure refrigerant circulates through either one of these modules. Thus, in a case where the first channel module 51, the second channel module 52, and the support member 12 are integrally formed, heat transfer occurs.

In the present embodiment, the first channel module 51, the second channel module 52, and the support member 12 are formed as separate members and disposed apart from each other, so that the heat transfer between these members can be reduced. Thus, the heat loss caused by the heat transfer can be reduced. That is, a decrease in the temperature of the high-temperature refrigerant and an increase in the temperature of the low-temperature refrigerant in the refrigerant channel of the refrigerant unit 10 can be suppressed, and the performance of the heat management system to which the refrigerant unit 10 is applied can be maintained.

As described above, in the first channel module 51, the connection portions 511, 512, 513, 751A, 751B, 752A, 752B are provided on the same plane on the first fixing surface side, and the attachment portions 518, 519 are provided on the same plane on the second fixing surface side. In the second channel module 52, the connection portions 521, 522, 851A, 851B, 852A, 852B are provided on the same plane on the first fixing surface side.

In this manner, by providing the connection portions on the predetermined plane without unevenness, the first channel module 51 and the second channel module 52 and the first heat exchanger 30 and the second heat exchangers 41, 42 connected thereto can be connected such that the refrigerant channel is shortened, and each device can be compactly disposed.

In the first channel module 51, the connection portions 751B, 752B located below in the vertical direction among the connection portions 751A, 751B, 752A, 752B with the expansion valves 71, 72 and the connection portions 511, 512 with the second heat exchangers 41, 42 are arranged at the same height in the vertical direction. With this configuration, it is possible to shorten the channel lengths of the refrigerant channel 51C between the second heat exchanger 41 and the expansion valve 71 and the refrigerant channel 51D between the second heat exchanger 42 and the expansion valve 72.

In the first channel module 51, the connection portions 751A, 752A located above in the vertical direction among the connection portions 751A, 751B, 752A, 752B with the expansion valves 71, 72 and the connection portion 513 with the first heat exchanger 30 are arranged at the same height in the vertical direction. With this configuration, it is possible to shorten the channel lengths of the refrigerant channel 51A between the first heat exchanger 30 and the expansion valve 71 and the refrigerant channel 51B between the first heat exchanger and the expansion valve 72.

Similarly, in the second channel module 52, the connection portions 851A, 852A located above in the vertical direction among the connection portions 851A, 851B, 852A, 852B with the electromagnetic valves 81, 82 and the connection portions 521, 522 with the second heat exchangers 41, 42 are arranged at the same height in the vertical direction. With this configuration, it is possible to shorten the channel lengths of the refrigerant channel 52C between the second heat exchanger 41 and the electromagnetic valve 81 and the refrigerant channel 52D between the second heat exchanger 42 and the electromagnetic valve 82,

In this manner, the channel lengths of the refrigerant channels 51A, 51B, 51C, 51D formed in the first channel module 51 and the refrigerant channels 52A, 52B, 52C, 52D formed in the second channel module 52 can be shortened. That is, the channel length of the channel for dividing or joining the refrigerant between the first heat exchanger 30 and the second heat exchangers 41, 42 can be shortened, and the performance of the refrigerant unit 10 can be improved.

In the support member 12, the first heat exchanger 30 and the second heat exchangers 41, 42 are fixed so as to be bridged between the horizontal portion 161 and the horizontal portion 162 on the first fixing surface to function as a beam, and the beam-like member 18 is provided so as to be bridged between the horizontal portion 161 and the horizontal portion 162 on the second fixing surface. With this configuration, the strength of the support member 12 can be improved to stably support the components of the refrigerant circuit, and the space 165 can be widely ensured to reduce the weight of the support member 12.

As described above, according to the present embodiment, in the refrigerant unit including the plurality of heat exchangers corresponding to the plurality of temperature adjustment targets, it is possible to reduce the heat exchangers having different functions from being thermally affected by each other and to respond to a desired temperature requirement for the temperature adjustment target.

Up to this point the embodiment of the present invention has been described in detail with reference to the drawings. However, the specific configuration is not limited to the embodiment above, and, for example, modifications made to the design without departing from the gist of the present invention are also included in the present invention.

### LIST OF REFERENCE SIGNS

10 Refrigerant Unit
11 Rubber Bush
12 Support Member
13 Fastener
15 Bottom Plate Portion
16 Frame Portion
18 Beam-Like Member
19 Bracket
20 Compressor
22 Accumulator
30 First Heat Exchanger
41, 42 Second Heat Exchanger
51 First Channel Module
52 Second Channel Module
51A, 51B, 51C, 51D, 52A, 52B, 52C, 52D Refrigerant Channel
60 Four-Way Valve
71, 72 Expansion Valve
71A, 71B, 72A, 72B Refrigerant Port
81, 82 Electromagnetic Valve
81A, 81B, 82A, 82B Refrigerant Port
91 to 94 Refrigerant Pipe
161, 162 Horizontal Portion
163, 164 Vertical Portion
165 Space
171, 172, 173 Fixing Piece
301, 302, 411, 412, 421, 422 Heat Medium Pipe
304, 305, 414, 415, 424, 425 Refrigerant Port
511, 512, 513, 751A, 751B, 752A, 752B Connection Portion
518, 519 Attachment Portion
521, 522, 529, 851A, 851B, 852A, 852B Connection Portion
S1, S2 Detection Device

1. A refrigerant unit comprising: a refrigerant circuit and a single support member that collectively supports a component of the refrigerant circuit,
wherein the refrigerant circuit includes a first heat exchanger and a second heat exchanger having different functions,
the first heat exchanger is disposed between a plurality of the second heat exchangers, and
a distance from one side of the plurality of second heat exchangers to the first heat exchanger is greater than a distance from the other side of the plurality of second heat exchangers to the first heat exchanger.

2. The refrigerant unit according to claim 1, wherein a decompression device of the refrigerant circuit is provided in each of a plurality of refrigerant channels connecting the one first heat exchanger and the plurality of second heat exchangers to each other.

3. The refrigerant unit according to claim 1, wherein in the support member, a compressor and a gas-liquid separator which are the component of the refrigerant circuit, are disposed on one side with respect to the member, and the first heat exchanger and the second heat exchanger are disposed on the other side with respect to the support member.

4. The refrigerant unit according to claim 3, wherein the support member has a width necessary and sufficient for disposing the compressor and the gas-liquid separator, and the width allows the first heat exchanger and the second heat exchanger to be dispersedly arranged.

5. The refrigerant unit according to claim 1, wherein the first heat exchanger and the plurality of second heat exchangers are heat exchangers having an equal heat exchange rate.
